(19) United States
(12) Patent Application Publication
(10) Pub. No.: US 2023/0353663 A1
(43) Pub. Date: Nov. 2, 2023

(54) ELECTRONIC CONTROL DEVICE, DATA COMMUNICATION METHOD, AND NON-TRANSITORY COMPUTER READABLE STORAGE MEDIUM

(71) Applicants: DENSO CORPORATION, Kariya-city (JP); TOYOTA JIDOSHA KABUSHIKI KAISHA, Toyota-shi (JP)

(72) Inventors: Toshinori TSUBOI, Kariya-city (JP); Ryota ARAI, Nagoya-shi (JP); Takashi HOSOI, Nagoya-shi (JP)

(21) Appl. No.: 18/304,384

(22) Filed: Apr. 21, 2023

(30) Foreign Application Priority Data
Apr. 27, 2022 (JP) 2022-073342

(51) Int. Cl. H04L 69/08; H04L 12/40

(52) U.S. Cl. CPC H04L 69/08; H04L 12/40; H04L 2012/40215

(57) ABSTRACT

An electronic control device includes: a data frame reception unit that receives a data frame of a first communication protocol from a first communication bus conforming to the first communication protocol; a reception time protocol conversion unit that protocol-converts the data frame of the first communication protocol received by the data frame reception unit into a data frame of a second communication protocol; a protocol data unit extraction unit that extracts a protocol data unit of the first communication protocol from the data frame of the second communication protocol protocol-converted by the reception time protocol conversion unit; and a protocol data unit provision unit provides the protocol data unit of the first communication protocol extracted by the protocol data unit extraction unit to an application.

### CROSS REFERENCE TO RELATED APPLICATIONS

The present application claims the benefit of priority from Japanese Patent Application No. 2022-073342 filed on Apr. 27, 2022. The entire disclosure of the above application is incorporated herein by reference.

### TECHNICAL FIELD

The present disclosure relates to an electronic control device, a data communication method and a non-transitory computer readable storage medium.

### BACKGROUND

For example, CAN (Controller Area Network, registered trademark) and Ethernet (registered trademark) are used as communication protocols for data communication between in-vehicle electronic control devices (hereinafter referred to as ECU, i.e., Electronic Control Units.

### SUMMARY

According to an example, an electronic control device may include: a data frame reception unit that receives a data frame of a first communication protocol from a first communication bus conforming to the first communication protocol; a reception time protocol conversion unit that protocol-converts the data frame of the first communication protocol received by the data frame reception unit into a data frame of a second communication protocol; a protocol data unit extraction unit that extracts a protocol data unit of the first communication protocol from the data frame of the second communication protocol protocol-converted by the reception time protocol conversion unit; and a protocol data unit provision unit provides the protocol data unit of the first communication protocol extracted by the protocol data unit extraction unit to an application.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram showing an embodiment;

FIG. 2 is a functional block diagram of a first control unit and CAN service;

FIG. 3 is a diagram showing a flow when CAN data is received;

FIG. 4 is a diagram showing the flow when the CAN data is transmitted;

FIG. 5 is a diagram for explaining protocol conversion;

FIG. 6 is a flowchart showing CAN data reception time processing;

FIG. 7 is a sequence diagram when receiving the CAN data;

FIG. 8 is a diagram showing a feature of accumulating CAN PDU when receiving the CAN data;

FIG. 9 is a diagram showing a feature of accumulating CAN PDU when receiving the CAN data;

FIG. 10 is a flowchart showing CAN data transmission time processing;

FIG. 11 is a sequence diagram when transmitting the CAN data;

FIG. 12 is a diagram showing a feature of accumulating CAN PDU when transmitting the CAN data; and

FIG. 13 is a diagram showing a feature of accumulating CAN PDU when transmitting the CAN data.

### DETAILED DESCRIPTION

In a conceivable technique, when the first control unit and the second control unit are mounted on the ECU and the first control unit is directly connected to the first communication bus conforming to the first communication protocol, the application to be executed by the first control unit can handle data of the first communication protocol. However, if the second control unit is not directly connected to the first communication bus, the application to be executed by the second control unit cannot handle data of the first communication protocol. In this way, there may be a difficulty that the development of the application is restricted by the connection form of the control unit that executes the application, and the degree of freedom in developing the application cannot be ensured.

The present embodiments have been made in view of the circumstances described above, and an object thereof is to provide an electronic control device, a data communication method, and a data communication program that can appropriately secure the degree of freedom in application development.

According to the first aspect of the embodiments, a data frame reception unit receives a data frame of a first communication protocol from a first communication bus conforming to the first communication protocol. A reception time protocol conversion unit protocol-converts the data frame of the first communication protocol received by the data frame reception unit into a data frame of a second communication protocol. A protocol data unit extraction unit extracts a protocol data unit of the first communication protocol from the data frame of the second communication protocol protocol-converted by the reception time protocol conversion unit. A protocol data unit provision unit provides the protocol data unit of the first communication protocol extracted by the protocol data unit extraction unit to an application.

When the data frame of the first communication protocol is received from the first communication bus, the received data frame of the first communication protocol is protocol-converted into the data frame of the second communication protocol. A protocol data unit of the first communication protocol is extracted from the protocol-converted data frame of the second communication protocol, and the extracted protocol data unit of the first communication protocol is provided to the application.

Even if the control unit for executing the application is not directly connected to the first communication bus, the protocol data unit stored in the data frame of the first communication protocol received from the first communication bus can be provided to the application, so that the application can handle data of the first communication protocol. As a result, application developer is not restricted by the connection form of the control unit for executing the application, and application developers can develop applications without considering differences in communication protocols. Thus, a sufficient degree of freedom for developing the application can be secured.

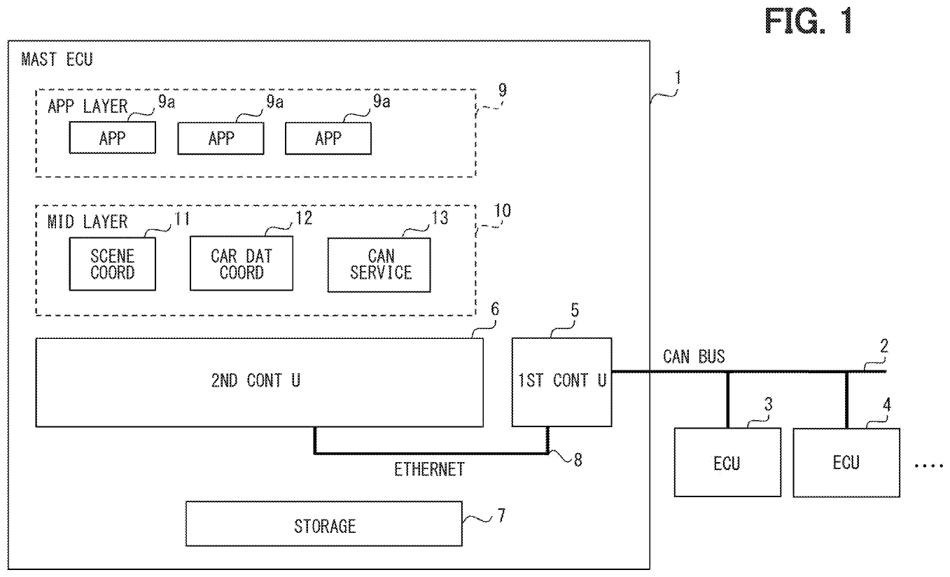

Hereinafter, one embodiment will be described with reference to the drawings. As shown in FIG. 1, a master ECU 1 mounted on a vehicle acquires information from, for example, a power train ECU, a body ECU, a cockpit ECU, a chassis ECU, a safety ECU, and the like, or instructs each ECU to control the vehicle. In order to realize this feature, the master ECU 1 includes multiple applications and multiple middleware. The master ECU 1 functions as an update master that manages the execution of reprogramming for the purpose of, for example, improving functions and recovering defects. The master ECU 1 is connected to a plurality of ECUs 3 and 4 via a CAN bus 2 (Controller Area Network bus, registered trademark, and corresponding to a first communication bus) so as to be capable of data communication, so that the master ECU 1 integrally manage the plurality of ECUs 3, 4 by instructing an operation to the plurality of ECUs 3, 4 and acquiring operating states from the plurality of ECUs 3, 4. The number of ECUs connected to the master ECU 1 via the CAN bus 2 may not be limited to two, but may be arbitrary. The plurality of ECUs 3 and 4 are, for example, a power train ECU, a body ECU, a cockpit ECU, a chassis ECU, a safety ECU, and the like.

The master ECU 1 is connected to a DCM (Data Communication Module) functioning as a data communication device. The DCM makes it possible to transmit and receive data by wirelessly connecting to the outside via a communication network. The master ECU 1 identifies a reprogramming target ECU that functions as a reprogramming target from among the plurality of ECUs, and executes reprogramming by instructing the reprogramming target ECU 3 to write an update program therein. The master ECU 1 is connected to a DCM (Data Communication Module) functioning as a data communication device. The DCM is wirelessly connected to an OTA center via a communication network so that a distribution package transmitted from the OTA center can be received. When receiving the distribution package transmitted from the OTA center, the DCM transmits the received distribution package to the master ECU 1. When the delivery package is transferred from the DCM, the master ECU 1 extracts the update program from the transferred delivery package and instructs the reprogram target ECU 3 to write the extracted update program, thereby executing the reprogramming.

The master ECU 1 includes a first control unit 5, a second control unit 6 (corresponding to a control unit), and a storage 7. The first control unit 5 and the second control unit 6 each include a microcomputer having a CPU (Central Processing Unit). The master ECU 1 has a ROM (i.e., Read Only Memory), a RAM (i.e., Random Access Memory) and an I/O (i.e., Input/Output). The first control unit 5 and the second control unit 6 each execute a control program stored in a non-transitory tangible storage medium to execute processing corresponding to the control program, and control a whole of operations of the master ECU 1 in cooperation with each other. The control programs respectively executed by the first control unit 5 and the second control unit 6 include a part of the data communication program.

The first control unit 5 is connected to the ECUs 3 and 4 via the CAN bus 2, and performs data communication with the ECUs 3 and 4 according to the CAN protocol (corresponding to the first communication protocol). The first control unit 5 and the second control unit 6 are connected via an Ethernet 8 (corresponding to a second communication bus), and perform data communication with each other according to the Ethernet protocol (corresponding to a second communication protocol). That is, the first controller 5 is directly connected to the CAN bus 2. The second control unit 6 is not directly connected to the CAN bus 2 but is connected to the CAN bus 2 via the Ethernet 8. Data communication by the Ethernet protocol is faster and has a larger capacity than data communication by the CAN protocol. The master ECU 1 is equipped with a plurality of CPUs. The first control unit 5 and the second control unit 6 correspond to multiple CPUs. In the hardware architecture of the master ECU 1, the first CPU is connected to the CAN bus 2 and is configured to directly access the CAN bus 2, and the second CPU is not connected to the CAN bus 2 and is configured not to directly access the CAN bus 2. Within the same board, the second CPU is connected to the first CPU via the Ethernet so as to be capable of data communication. Here, instead of a plurality of CPUs, virtual machines that implement the same functions by software may be used.

The storage 7 is a nonvolatile memory mainly including, for example, a NOR flash memory or a NAND flash memory, and is shared by multiple applications executed by the first control unit 5 and the second control unit 6. That is, a plurality of applications each access the storage 7 to write and read data. Although the configuration in which the storage 7 is built in the master ECU 1 is exemplified in this embodiment, it may be also possible to apply a configuration in which the storage 7 is arranged outside the master ECU 1. Further, although the configuration in which the storage 7 is shared by a plurality of applications executed by the first control unit 5 and the second control unit 6 is illustrated, the application executed by the control unit of another ECU connected to the master ECU 1 for data communication may share the storage 7.

Each application 9a belonging to the application layer 9 requests to transmit the information to any one of the scene coordinator 11, the car data coordinator 12, and the CAN service 13 belonging to the middleware layer 10 according to the granularity of the requested information when requesting the information about the vehicle. The scene coordinator 11, the car data coordinator 12, and the CAN service 13 each are set with application programming interfaces (APIs) so that information can be provided.

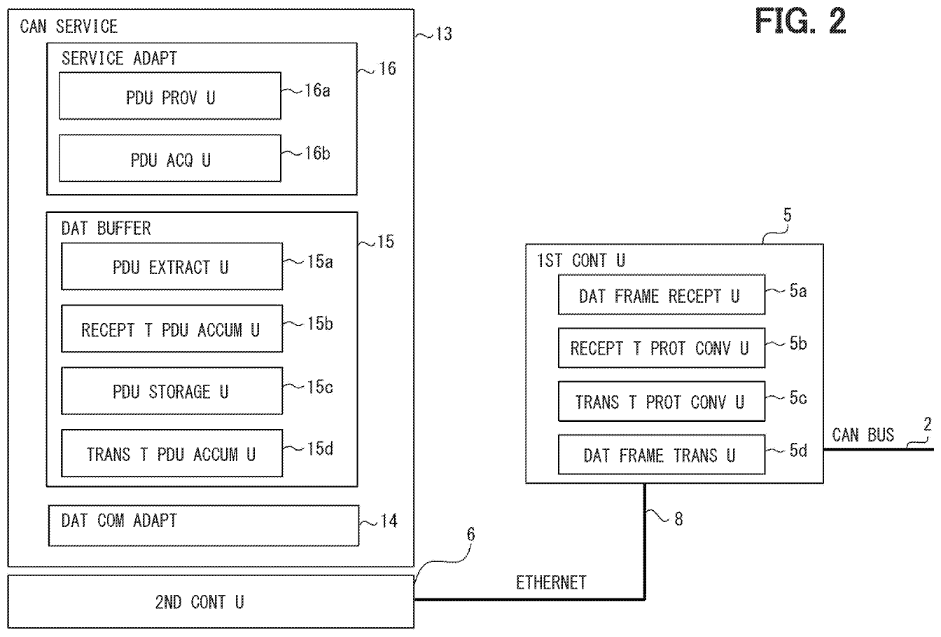

Since the first control unit 5 is directly connected to the CAN bus 2 as described above, it has a function of controlling transmission and reception of CAN frames including CAN data, which conforms to the CAN protocol. As shown in FIG. 2, the first control unit 5 includes a data frame reception unit 5a and a reception time protocol conversion unit 5b as functional blocks involved in receiving data from the CAN bus 2. The first control unit 5 includes, as functional blocks involved in transmitting the CAN data to the CAN bus 2, a transmission time protocol conversion unit 5c and a data frame transmission unit 5d.

The CAN service 13 includes a data communication adapter 14, a data buffer 15 and a service adapter 16. The data communication adapter 14 controls transmission and reception of Ethernet frames, which are data frames conforming to the Ethernet protocol.

The data buffer 15 includes a protocol data unit (hereinafter referred to as a PDU, Protocol Data Unit) extraction unit 15a and a reception time PDU accumulation unit 15b as functional blocks involved in receiving the CAN data from the first control unit 5. The data buffer 15 includes a PDU storage unit 15c and a transmission time PDU accumulation unit 15d as functional blocks involved in transmitting the CAN data to the first control unit 5. The PDU is a unit of information that is transmitted and received, and includes a portion of control information defined by a communication protocol and a payload that is the content of data.

The service adapter 16 provides the application 9a with a CAN PDU including CAN data, which is data conforming to the CAN protocol, and acquires the CAN PDU from the application 9a. The service adapter 16 includes a PDU provision unit 16a as a functional block involved in receiving the CAN data from the first control unit 5. The service adapter 16 includes a PDU acquisition unit 16b as a functional block involved in transmitting the CAN data to the first control unit 5.

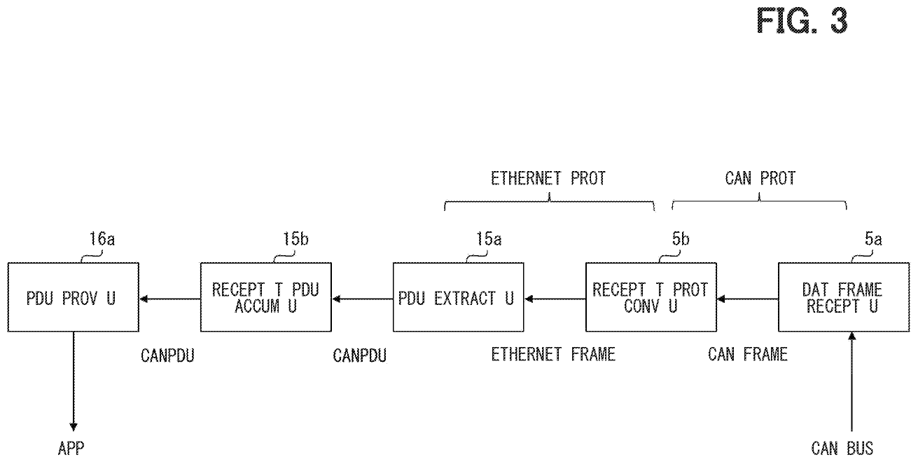

When the CAN data handled by the application 9a is received, the first control unit 5 and the CAN service 13 operate in cooperation with each other. As shown in FIG. 3, the data frame reception unit 5a, the reception time protocol conversion unit 5b, the PDU extraction unit 15a, the reception time PDU accumulation unit 15b, and the PDU provision unit 16a perform the following operations when receiving the CAN data. The data frame reception unit 5a receives the CAN frames from the CAN bus 2. The reception time protocol conversion unit 5b protocol-converts the CAN frame received by the data frame reception unit 5a into an Ethernet frame. The PDU extraction unit 15a extracts the CAN PDU from the Ethernet frame protocol-converted by the reception time protocol conversion unit 5b.

The reception time PDU accumulation unit 15b functions as a FIFO buffer for CAN PDUs extracted by the PDU extraction unit 15a, and accumulates the CAN PDUs extracted by the PDU extraction unit 15a. The PDU provision unit 16a provides the application 9a with the CAN PDUs accumulated by the reception time PDU accumulation unit 15b. In this case, since the reception time PDU accumulation unit 15b functions as a FIFO buffer, the PDU provision unit 16a provides the CAN PDUs accumulated by the reception time PDU accumulation unit 15b to the application 9a according to the order in which the CAN frames have been received from the CAN bus 2. That is, according to the order in which the CAN frames are received from the CAN bus 2, the CAN PDUs extracted from the received CAN frames are provided to the application 9a.

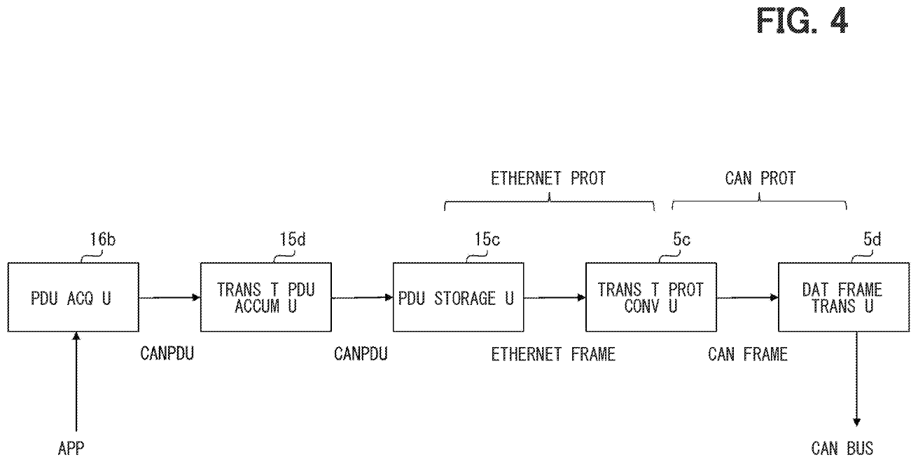

When the CAN data handled by the application 9a is transmitted, the first control unit 5 and the CAN service 13 operate in cooperation with each other. As shown in FIG. 4, the PDU acquisition unit 16b, the transmission time PDU accumulation unit 15d, the PDU storage unit 15c, the transmission time protocol conversion unit 5c, and the data frame transmission unit 5d perform the following operations when transmitting the CAN data. The PDU acquisition unit 16b acquires the CAN PDU from the application 9a. The transmission time PDU accumulation unit 15d functions as a FIFO buffer for CAN PDUs acquired by the PDU acquisition unit 16b, and accumulates the CAN PDUs acquired by the PDU acquisition unit 16b. The PDU storage unit 15c stores the CAN PDUs accumulated by the transmission time PDU accumulation unit 15d in an Ethernet frame.

The transmission time protocol conversion unit 5c protocol-converts the Ethernet frame in which the CAN PDU is stored by the PDU storage unit 15c into a CAN frame. The data frame transmission unit 5d transmits to the CAN bus 2 the CAN frame protocol-converted by the transmission time protocol conversion unit 5c. In this case, since the transmission time PDU accumulation unit 15d functions as a FIFO buffer, the data frame transmission unit 5d transmits the CAN frames protocol-converted by the transmission time protocol conversion unit 5c to the CAN bus 2 according to the order in which the CAN PDUs have been acquired from the application 9a. That is, the CAN frame in which the acquired PDUs are stored is transmitted to the CAN bus 2 according to the order in which the CAN PDUs are acquired from the application 9a.

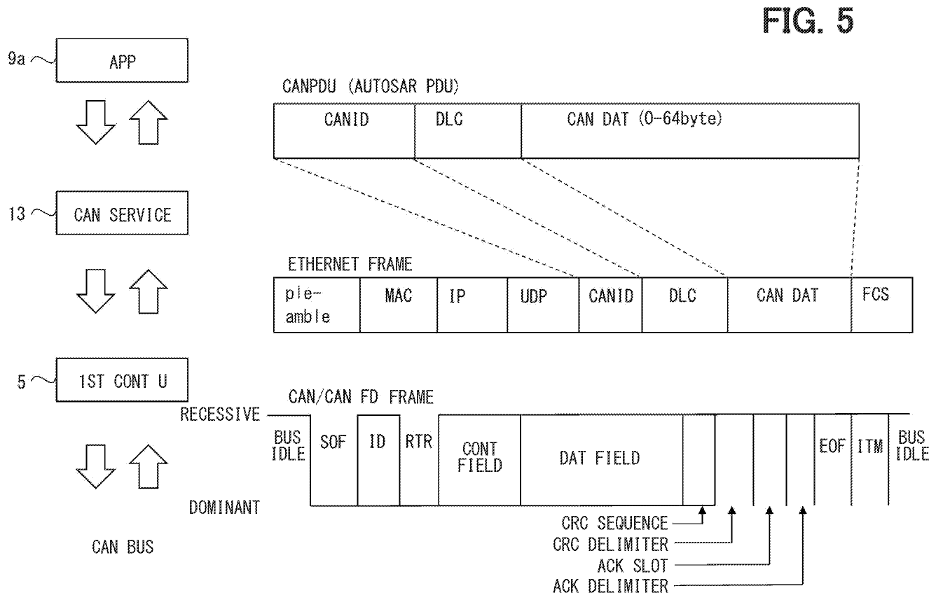

As shown in FIG. 5, when receiving the CAN data handled by the application 9a, the CAN frame received from the CAN bus 2 is protocol-converted into an Ethernet frame, and the CAN PDU extracted from the protocol-converted Ethernet frame is provided to the application 9a. When transmitting the CAN data handled by the application 9a, the Ethernet frame storing the CAN PDU is protocol-converted into a CAN frame, and the protocol-converted CAN frame is transmitted to the CAN bus 2. The ID, the control field, and the data field of the CAN frame correspond to a CANID, a DLC, and a CAN data of the Ethernet frame, respectively.

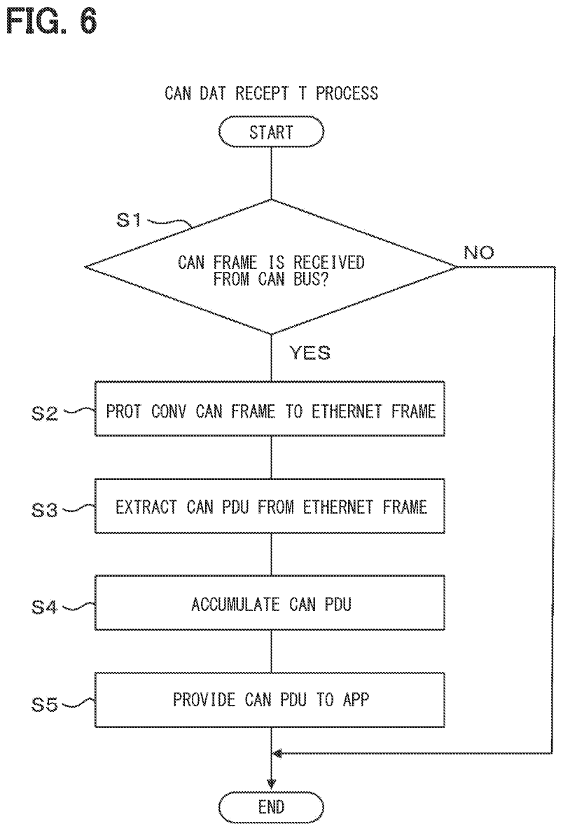

The following will describe an operation of the above configuration with reference to FIG. 6 to FIG. 13. A process performed by the master ECU 1 when receiving the CAN data and a process when transmitting the CAN data will be described.

### (1) Processing when Receiving CAN Data (see FIGS. 6 to 9)

When the master ECU 1 starts the CAN data reception time process, the master ECU 1 determines whether or not the first control unit 5 has received a CAN frame from the CAN bus 2. When the master ECU 1 determines that the first control unit 5 has received a CAN frame from the CAN bus 2 (at S1, which corresponds to a data frame reception procedure), it protocol-converts the received CAN frame into an Ethernet frame (at S2, which corresponds to a reception time protocol conversion procedure). The master ECU 1 extracts CAN PDU from the protocol-converted Ethernet frame using the CAN service 13 (at S3, corresponding to a PDU extraction procedure), and accumulates the extracted CAN PDU (at S4, corresponding to a reception time PDU extraction procedure). The master ECU 1 provides the accumulated CAN PDU to the application 9a (at S5, which corresponds to a PDU extraction procedure), and terminates the CAN data reception time process.

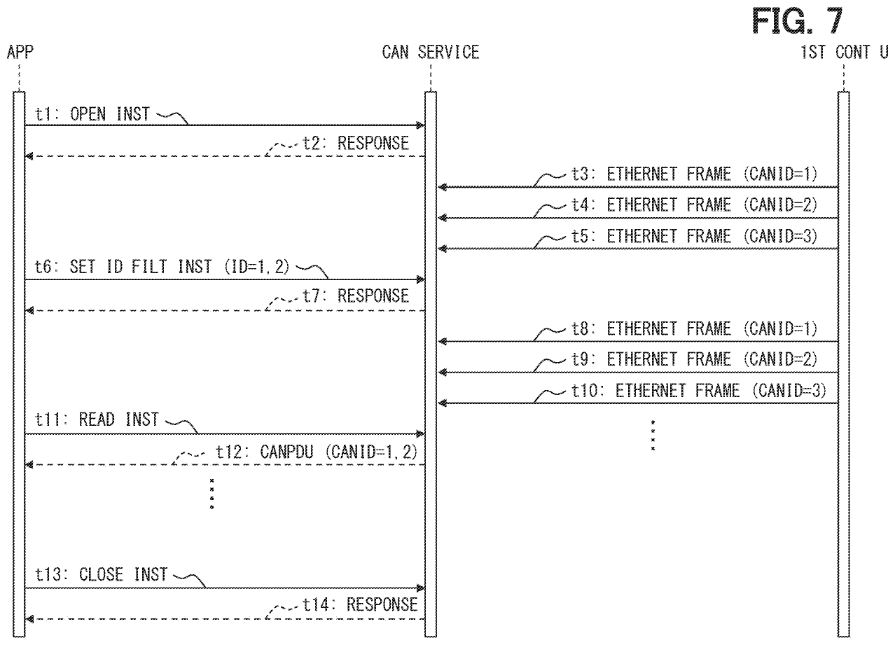

In this case, the CAN service 13 performs the processing shown in FIG. 7. When the application 9a notifies the CAN service 13 of the open instruction (at t1), the CAN service 13 notifies the application 9a of a response to the notified open instruction (at t2), and creates a temporary data storage area in the reception time PDU accumulation unit 15b for the application 9a as a notification source of the open instruction. When the CAN service 13 receives an Ethernet frame from the first control unit 5 (at t3 to t5), the CAN service 13 discards the received Ethernet frame if no set ID filter instruction is notified from application 9a.

When notified of the set ID filter instruction from the application 9a (at t6), the CAN service 13 notifies the application 9a of a response to the notified set ID filter instruction (at t7). When the CAN service 13 receives the Ethernet frame from the first control unit 5 (at t8 to t10), if the set ID filter instruction is notified from the application 9a, the CAN server 13 checks the ID specified by the notified set ID filter instruction with the CANID stored in the received Ethernet frame. When the CAN service 13 specifies an Ethernet frame storing a CANID that matches the ID designated by the notified set ID filter instruction, it extracts a CAN PDU from the specified Ethernet frame, and stores the extracted CAN PDU in the data storage area. When the CAN service 13 specifies an Ethernet frame storing a CANID that does not match the ID specified by the notified set ID filter instruction, it discards the Ethernet frame from the specified Ethernet frame without extracting the CAN PDU. When the application 9a notifies the CAN service 13 of the read instruction (at t11), the CAN service 13 provides the CAN PDU stored in the data storage area to the application 9a (at t12).

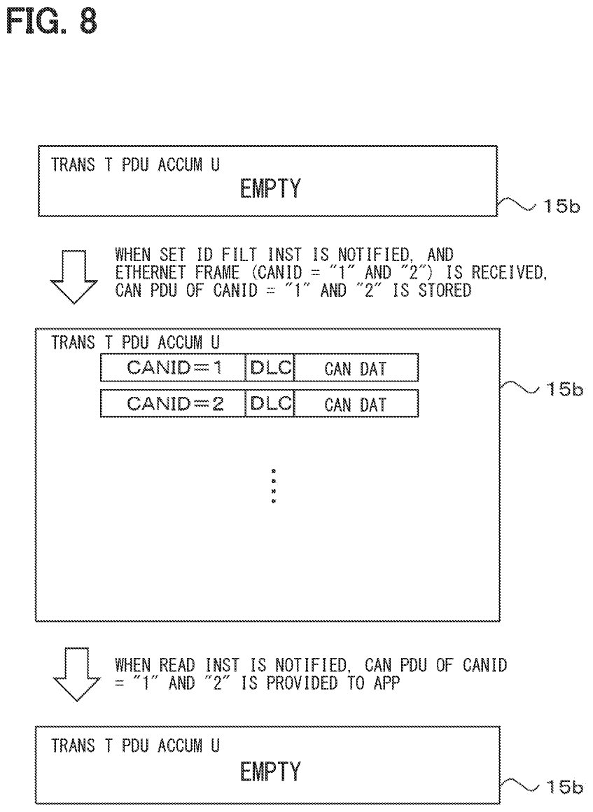

In the example of FIG. 7, the CAN service 13 provides the CAN PDUs with CANID=“1” and “2” to the application 9a when the CAN PDUs with CANID=“1” and “2” is stored in the data storage area and the read instruction is notified from the application 9a since the ID=“1” and “2” are specified in the set ID filter instruction notified from the application 9a. In this case, as shown in FIG. 8, when the CAN service 13 provides the CAN PDUs with CANID=“1” and “2” to the application 9a, the CAN service 13 sets the data storage area in the reception time PDU accumulation unit 15b to be in an empty state. The CAN service 13 repeats the processing described above.

When the CAN service 13 receives an Ethernet frame multiple times from the first control unit 5 before being notified of the read instruction from the application 9a after being notified of the set ID filter instruction from the application 9a, the CAN service 13 extracts the CAN PDUs sequentially from Ethernet frames storing the CAN IDs that match the IDs specified by the notified set ID filter instruction, and sequentially stores the extracted CAN PDUs in the data storage area.

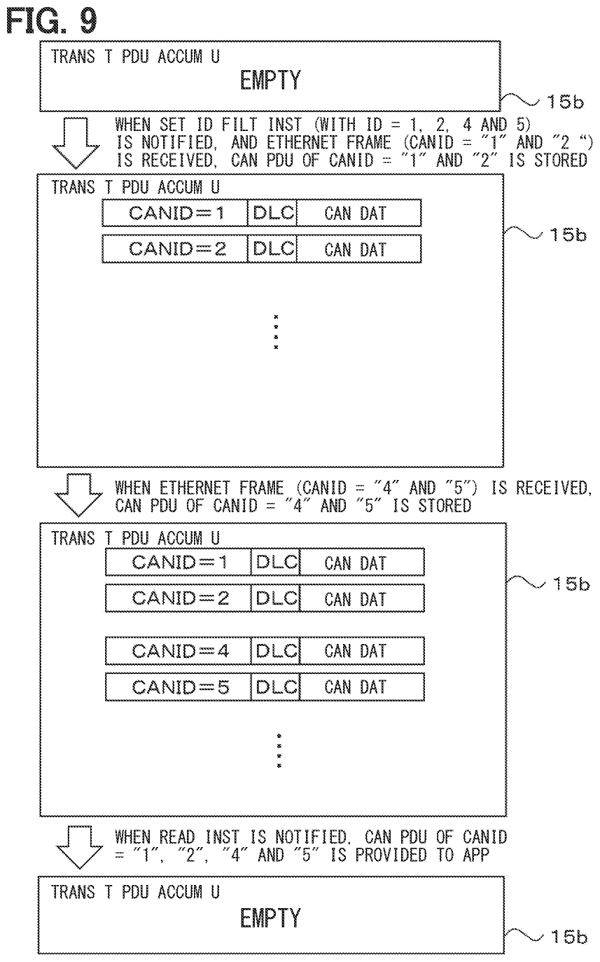

In the example of FIG. 9, the CAN service 13 stores the CAN PDU with the CANID=“1” and “2” in the data storage area when receiving the Ethernet frame storing the CANID=“1” and “2” from the first control unit 5, and successively, when receiving the Ethernet frame storing the CANID=“4” and “5” from the first control unit 5, the CAN service 13 stores the CAN PDU with the CANID=“4” and “5” in the data storage area since the ID=“1”, “2”, “4”, and “5” is specified in the set ID filter instruction notified from the application 9a.

When the CAN service 13 is notified of the close instruction from the application 9a (at t13), the CAN service 13 notifies the application 9a of a response to the notified close instruction (at t14), and deletes the temporary data storage area created in the reception time PDU accumulation unit 15b. By the above-described processing, the CAN PDU stored in the CAN frame received from the CAN bus 2 can be provided to the application 9a, and the application 9a can handle the CAN data.

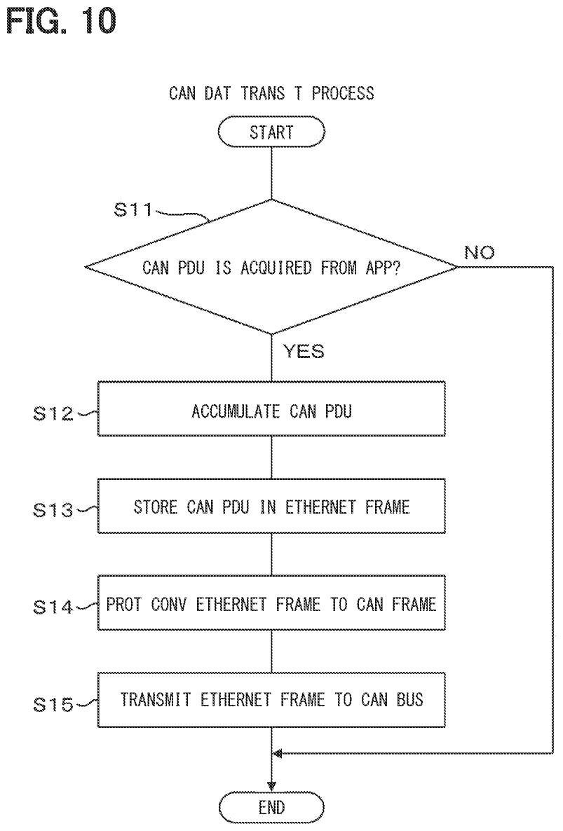

### (1) Processing when Transmitting CAN Data (see FIGS. 10 to 13)

When the master ECU 1 starts the CAN data transmission time process, the master ECU 1 determines whether or not the CAN PDU is obtained from the application 9a by the CAN service 13 (at S11). When the master ECU 1 determines that the CAN PDU has been acquired from the application 9a by the CAN service 13 (“YES” at S11, corresponding to the PDU acquisition procedure), it accumulates the acquired CAN PDU (at S12, corresponding to the transmission time PDU accumulation procedure). The master ECU 1 stores the accumulated CAN PDU in an Ethernet frame (at S13, corresponding to a PDU storage procedure), and protocol-converts the Ethernet frame storing the CAN PDU into a CAN frame (at S14, corresponding to a transmission time protocol conversion procedure). The master ECU 1 transmits the converted CAN frame to the CAN bus 2 (at S15, corresponding to the data frame transmission procedure), and terminates the CAN data transmission time process.

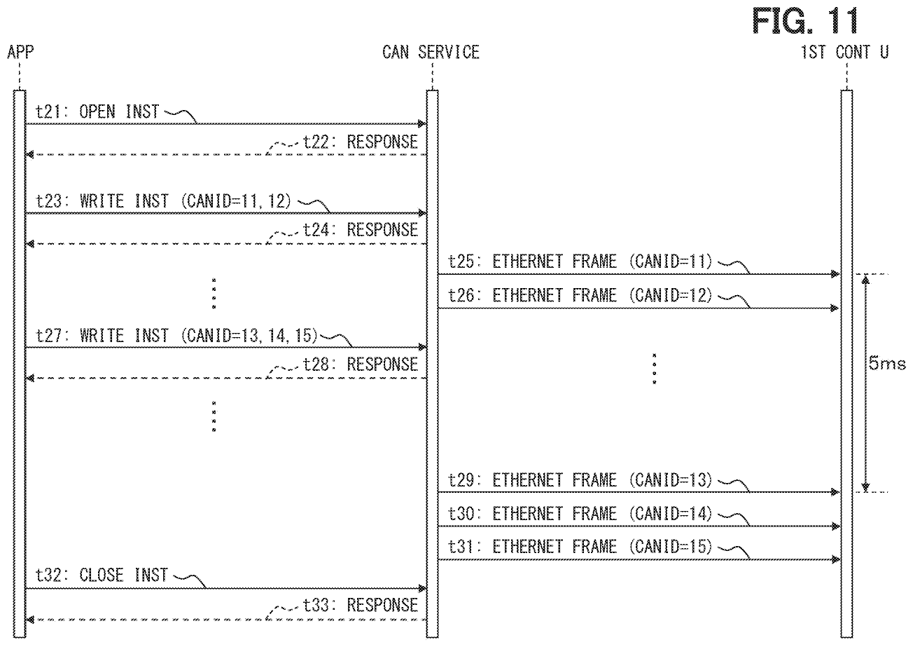

In this case, the CAN service 13 performs the processing shown in FIG. 11. When the application 9a notifies the CAN service 13 of the open instruction (at t21), the CAN service 13 notifies the application 9a of a response to the notified open instruction (at t22), and creates a temporary data storage area in the transmission time PDU accumulation unit 15d for the application 9a as a notification source of the open instruction. When the CAN service 13 is notified of the write instruction from the application 9a (at t23), the CAN service 13 notifies the application 9a of a response to the notified write instruction (at t24), acquires the CAN PDU from the application 9a, and stores the acquired CAN PDU to the application 9a in the data storage area.

The CAN service 13 monitors a predetermined transmission cycle of Ethernet frames (for example, a cycle of 5 milliseconds). When the CAN PDU is stored at the time when the transmission timing of the Ethernet frame is reached, the CAN service 13 stores the stored CAN PDU in the Ethernet frame, and transmits the Ethernet frame storing the CAN PDU to the first control unit 5 (at t25 and t26), and waits for the transmission timing of the next Ethernet frame. The CAN service 13 waits for the transmission timing of the next Ethernet frame if the CAN PDU has not been stored when the transmission timing of the Ethernet frame is reached.

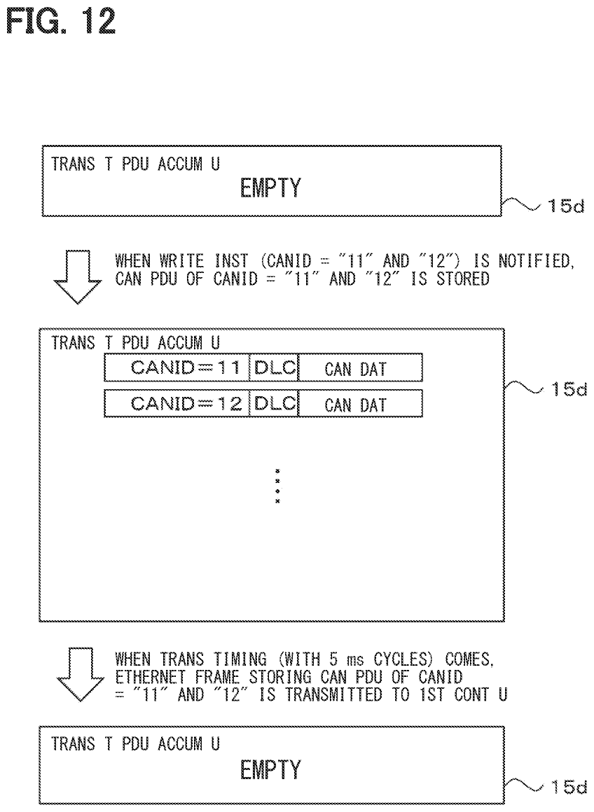

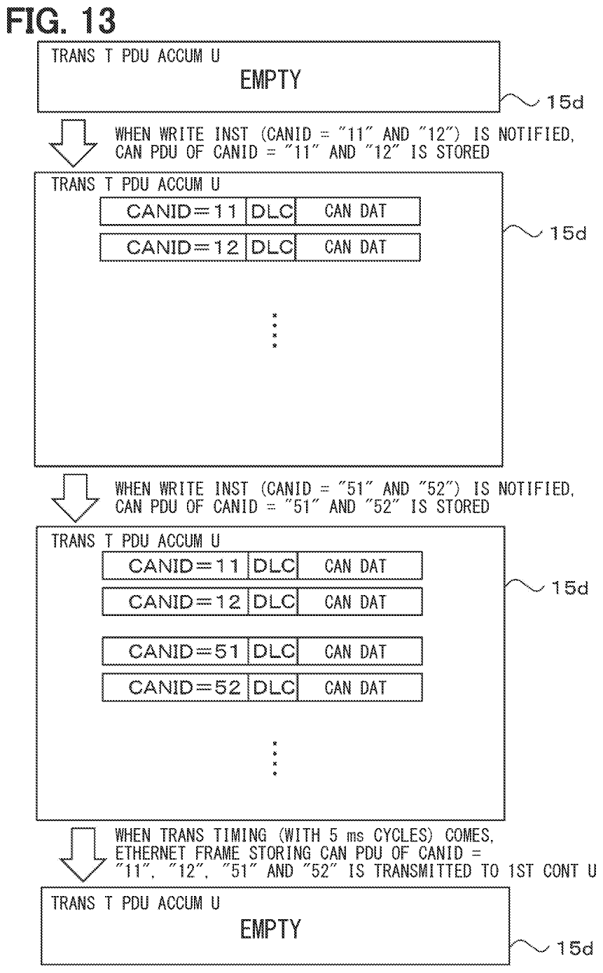

In the example of FIG. 12, since the CAN service 13 is notified of the write instruction from the application 9a, and acquires the CAN PDU with CANID=“11” and “12”, the CAN service 13 stores the acquired CANID=“11” and “12” in the data storage area, and when the transmission timing of the Ethernet frame is reached, the CAN service 13 transmits the Ethernet frame storing the CAN PDU to the first control unit 5. In this case, as shown in FIG. 13, when the CAN service 13 transmits an Ethernet frame storing the CAN PDU with CANID=“11” and “12” to the first control unit 5, the CAN service 13 sets the data storage area in the transmission time PDU accumulation unit 15 to be in an empty state. The CAN service 13 repeats the above process (at t27 to t31).

Note that when the CAN service 13 is notified of the write instruction multiple times from the application 9a before reaching the transmission timing of the next Ethernet frame after reaching the transmission timing of the Ethernet frame, it sequentially acquires CAN PDUs from the application 9a, and then, stores the acquired CAN PDU sequentially in the data storage area.

In the example of FIG. 13, the CAN service 13 stores the CAN PDU with CAN ID=“11” and “12” in the data storage area, and then stores the CAN PDU with CAN ID=“51” and “52” in the data storage area, and, when it reaches the transmission timing of the Ethernet frame, the CAN service 13 transmits to the first control unit 5 the Ethernet frame storing the CAN PDUs of CAN ID=“11”, “12”, “51” and “52”.

When the CAN service 13 is notified of the close instruction from the application 9a (at t32), the CAN service 13 notifies the application 9a of a response to the notified close instruction (at t33), and deletes the temporary data storage area created in the transmission time PDU accumulation unit 15d. By the above-described processing, the CAN frame storing the CAN PDU with the CAN data can be transmitted to the CAN bus 2, and the application 9a can handle the CAN data.

As described above, according to the present embodiment, the following actions and effects can be achieved.

When the master ECU 1 receives a CAN frame from the CAN bus 2, it protocol-converts the received CAN frame into an Ethernet frame, extracts CAN PDU from the protocol-converted Ethernet frame, and provides the extracted CAN PDU to the application.

Even if the second control unit 6 that executes the application 9a is not directly connected to the CAN bus 2, the CAN PDU stored in the CAN frame received from the CAN bus 2 can be provided to the application 9a, so that the application 9a can handle the CAN data. As a result, application developer is not restricted by the connection form of the control unit for executing the application, and application developers can develop applications without considering differences in communication protocols. Thus, a sufficient degree of freedom for developing the application can be secured. That is, the application developer of the application 9a does not need to consider which of the first control unit 5 and the second control unit 6 executes the application 9a.

When the CAN PDU is acquired from the application 9a, the master ECU 1 stores the acquired CAN PDU in an Ethernet frame, protocol-converts the Ethernet frame storing the CAN PDU into a CAN frame, and transmits the protocol-converted CAN frame to the CAN bus 2.

Even if the second control unit 6 that executes the application 9a is not directly connected to the CAN bus 2, it is possible to transmit the CAN frame storing the CAN data to be handled by the application 9a to the CAN bus 2. As a result, an application developer can develop applications without considering differences in communication protocols not only for the CAN data to be received from the CAN bus 2 but also for the CAN data to be transmitted to the CAN bus 2, so that a sufficient degree of freedom in the development of application can be ensured.

Since the master ECU 1 is provided with a configuration that functions as a FIFO buffer for the CAN PDUs when receiving the CAN data, the master ECU 1 can properly provide the CAN PDUs stored in the received CAN frames to the application 9a according to the order in which the CAN frames are received from the CAN bus 2.

Since the master ECU 1 is provided with a configuration that functions as a FIFO buffer for the CAN PDUs when transmitting the CAN data, the master ECU 1 can transmit the CAN frames obtained by protocol-converting Ethernet frames to the CAN bus 2 according to the order in which the CAN PDUs are acquired from the application 9a.

In the above, the configuration is exemplified such that the CAN bus 2 and the Ethernet 8 are used as the communication buses, and the protocol conversion between the CAN frame and the Ethernet frame is performed. Alternatively, LIN, CXPI (i.e., Clock Extension Peripheral Interface, registered trademark), FLEXRAY (registered trademark), MOST (Media Oriented Systems Transport, registered trademark), and the like may be employed as the communication protocol.

Although the present disclosure has been described in accordance with the embodiments, it is understood that the present disclosure is not limited to the embodiments and structures described above. The present disclosure includes various modification examples or variations within the scope of equivalents. Various combinations or forms as well as other combinations or forms including only one element, one or more elements, or one or less elements, fall within the scope or the spirit of the present disclosure.

The control unit and the method according to the present disclosure may be achieved by a dedicated computer provided by constituting a processor and a memory programmed to execute one or more functions embodied by a computer program. Alternatively, the controller and the method thereof described in the present disclosure may be implemented by a dedicated computer provided by configuring a processor with one or more dedicated hardware logic circuits. Alternatively, the control unit and the method thereof described in the present disclosure may be implemented by one or more dedicated computers configured by a combination of a processor and a memory programmed to execute one or more functions and a processor configured by one or more hardware logic circuits. The computer program may be stored in a computer-readable non-transitional tangible recording medium as an instruction to be executed by the computer.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

What is claimed is:

1. An electronic control device comprising:
a control unit that executes an application;
a data frame reception unit that receives a data frame of a first communication protocol from a first communication bus conforming to the first communication protocol;
a reception time protocol conversion unit that protocol-converts the data frame of the first communication protocol received by the data frame reception unit into a data frame of a second communication protocol;
a protocol data unit extraction unit that extracts a protocol data unit of the first communication protocol from the data frame of the second communication protocol protocol-converted by the reception time protocol conversion unit; and
a protocol data unit provision unit that provides the protocol data unit of the first communication protocol extracted by the protocol data unit extraction unit to an application.

2. The electronic control device according to claim 1, further comprising:
a protocol data unit acquisition unit that acquires the protocol data unit of the first communication protocol from the application;
a protocol data unit storage unit that stores the protocol data unit of the first communication protocol acquired by the protocol data unit acquisition unit in the data frame of the second communication protocol;
a transmission time protocol conversion unit that protocol-converts the data frame of the second communication protocol, in which the protocol data unit of the first communication protocol is stored by the protocol data unit storage unit, into the data frame of the first communication protocol; and
a data frame transmission unit that transmits the data frame of the first communication protocol, which is protocol-converted by the transmission time protocol conversion unit, to the first communication bus.

3. The electronic control device according to claim 1, further comprising:
a reception time protocol data unit accumulation unit that accumulates the protocol data unit of the first communication protocol extracted by the protocol data unit extraction unit, wherein:
the protocol data unit provision unit provides the protocol data unit of the first communication protocol, which is accumulated by the reception time protocol data unit accumulation unit, to the application.

4. The electronic control device according to claim 2, further comprising:
a transmission time protocol data unit accumulation unit that accumulates the protocol data unit of the first communication protocol acquired by the protocol data unit acquisition unit, wherein:
the protocol data unit storage unit stores the protocol data unit of the first communication protocol, which is accumulated by the transmission time protocol data unit accumulation unit, in the data frame of the second communication protocol.

5. The electronic control device according to claim 1, wherein:
the protocol data unit provision unit provides the protocol data unit of the first communication protocol, which is extracted by the protocol data unit extraction unit, to the application according to an order in which the data frame of the first communication protocol is received by the data frame reception unit from the first communication bus.

6. The electronic control device according to claim 2, wherein:
the data frame transmission unit transmits the data frame of the first communication protocol, which is protocol-converted by the transmission time protocol conversion unit, to the first communication bus according to an order in which the protocol data unit of the first communication protocol is acquired by the protocol data unit acquisition unit from the application.

7. The electronic control device according to claim 1, wherein:
the control unit includes a first control unit and a second control unit;
the reception time protocol conversion unit is disposed in the first control unit, the protocol data unit extraction unit and the protocol data unit provision unit are disposed in the second control unit, and
the first control unit and the second control unit perform data communication using the second communication protocol.

8. The electronic control device according to claim 2, wherein:
the control unit includes a first control unit and a second control unit;
the protocol data unit acquisition unit and the protocol data unit storage unit are disposed in the second control unit,
the transmission time protocol conversion unit is disposed in the first control unit, and
the first control unit and the second control unit perform data communication using the second communication protocol.

9. The electronic control device according to claim 1, further comprising:
one or more processors, wherein:
the one or more processors provides at least one of: the data frame reception unit; the reception time protocol conversion unit; the protocol data unit extraction unit;
and the protocol data unit provision unit.

10. A data communication method for an electronic control device including a control unit that executes an application, the data communication method comprising:
a data frame reception procedure for receiving a data frame of a first communication protocol from a first communication bus conforming to the first communication protocol;
a reception time protocol conversion procedure for protocol-converting the data frame of the first communication protocol received in the data frame reception procedure into a data frame of a second communication protocol;
a protocol data unit extraction procedure for extracting a protocol data unit of the first communication protocol from the data frame of the second communication protocol protocol-converted in the reception time protocol conversion procedure; and
and a protocol data unit provision procedure for providing the protocol data unit of the first communication protocol extracted by the protocol data unit extraction procedure to an application.

11. The data communication method according to claim 10, further comprising:
a protocol data unit acquisition procedure for acquiring the protocol data unit of the first communication protocol from the application;
a protocol data unit storage procedure for storing the protocol data unit of the first communication protocol acquired in the protocol data unit acquisition procedure in the data frame of the second communication protocol;
a transmission time protocol conversion procedure for protocol-converting the data frame of the second communication protocol, in which the protocol data unit of the first communication protocol is stored in the protocol data unit storage procedure, into the data frame of the first communication protocol; and
a data frame transmission procedure for transmitting the data frame of the first communication protocol protocol-converted in the transmission time protocol conversion procedure to the first communication bus.

12. A non-transitory computer readable storage medium comprising instructions being executed by a computer, the instructions causing an electronic control device, including a control unit that executes an application, to execute:
a data frame reception procedure for receiving a data frame of a first communication protocol from a first communication bus conforming to the first communication protocol;
a reception time protocol conversion procedure for protocol-converting the data frame of the first communication protocol received in the data frame reception procedure into a data frame of a second communication protocol;
a protocol data unit extraction procedure for extracting a protocol data unit of the first communication protocol from the data frame of the second communication protocol protocol-converted in the reception time protocol conversion procedure; and
and a protocol data unit provision procedure for providing the protocol data unit of the first communication protocol extracted by the protocol data unit extraction procedure to an application.

13. The non-transitory computer readable storage medium according to claim 12, the instructions further causing the electronic control device to execute:
a protocol data unit acquisition procedure for acquiring the protocol data unit of the first communication protocol from the application;
a protocol data unit storage procedure for storing the protocol data unit of the first communication protocol acquired in the protocol data unit acquisition procedure in the data frame of the second communication protocol;
a transmission time protocol conversion procedure for protocol-converting the data frame of the second communication protocol, in which the protocol data unit of the first communication protocol is stored in the protocol data unit storage procedure, into the data frame of the first communication protocol; and
a data frame transmission procedure for transmitting the data frame of the first communication protocol, protocol-converted in the transmission protocol conversion procedure, to the first communication bus.
